(19) United States
(12) Patent Application Publication
(10) Pub. No.: US 2002/0143739 A1
(43) Pub. Date: Oct. 3, 2002

(54) Computer program product, method, and system of document analysis

(76) Inventors: Kyoko Makino, Yokohama-shi (JP); Seiji Iwata, Hachioji-shi (JP); Kayoko Kameda, Kawasaki-shi (JP); Naomaru Kawasaki, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/098,567

(22) Filed: Mar. 18, 2002

(30) Foreign Application Priority Data
Mar. 19, 2001 (JP) 2001-079349

(51) Int. Cl. G06F 7/00

(52) U.S. Cl. 707/1

(57) ABSTRACT

With the present invention, a computer system that deals with a large amount of document data can easily grasp significant information. A computer program product of the present invention refers to term definition dictionary data including summary elements defined as elements to be extracted in order to be included in a summary, extracts the summary elements included in a document data to be analyzed, combines the extracted summary elements in accordance with a predetermined rule and generates summary information of the document data to be analyzed, and links the document data to be analyzed with the summary information.

### CROSS-REFERENCE TO RELATED APPLICATIONS

This application is based upon and claims the benefit of priority from the prior Japanese Patent Application No. 2001-079349, filed Mar. 19, 2001, the entire contents of which are incorporated herein by reference.

### BACKGROUND OF THE INVENTION

1. Field of the Invention

The present invention relates to a computer program product, a document analysis method and a document analysis system, which assist a work of analyzing document data.

2. Description of Related Art

Development of technologies, such as the Internet, intranets or extranets, has allowed contrivance of information gathering or information sharing in a company or between companies.

The companies try to effectively utilize the gathered information by performing various analyses on the information.

However, when company manages data such as daily report data by a computer system, an enormous number of items of data may be collected. In this case, it may be difficult for the user of the computer system to grasp significant information included in the collected dairy report data.

Further, if the amount of collected dairy report data is large, the user must labor considerably to retrieve the dairy report data for a significant or characteristic portion.

Thus, there is a demand for improvement of the efficiency of the work of grasping significant or characteristic information from the dairy report data.

Furthermore, it is desired that the operability of the system be improved so that the user can appropriately grasp significant or characteristic information included in the collected data.

### BRIEF SUMMARY OF THE INVENTION

An object of the present invention is to provide a computer program product, a document analysis method and a document analysis system, which can easily grasp significant information in a computer system that deals with a large amount of document data.

According to an embodiment of the present invention, there is provided an article of manufacture comprising a computer usable medium having computer readable program code means embodied therein, the computer program code means comprising:

a computer readable program code that refers to term definition dictionary data including summary elements defined as elements to be extracted in order to be included in a summary, and extracts the summary elements included in document data to be analyzed;

a computer readable program code that combines the extracted summary elements in accordance with a predetermined rule and generates summary information of the document data to be analyzed; and

a computer readable program code that links the document data to be analyzed with the summary information.

According to a still another embodiment of the present invention, there is provided an article of manufacture comprising a computer usable medium having computer readable program code means embodied therein, the computer program code means comprising:

a first computer readable program code that refers to term definition dictionary data including summary elements defined as elements to be extracted in order to be included in a summary, and extracts the summary elements included in document data to be analyzed;

a second computer readable program code that combines the extracted summary elements in accordance with a predetermined rule and generates summary information of the document data to be analyzed;

a third computer readable program code that links the document data to be analyzed with the summary information; and

a fourth computer readable program code that, when a designation of the summary information from a user is received, searches the document data to be analyzed corresponding to the designated summary information based on a link result between the document data to be analyzed and the summary information, and generates screen data including the designated summary information and the searched document data to be analyzed.

According to a still another embodiment of the present invention, there is provided a method of document analysis by a computer, comprising:

referring to term definition dictionary data including summary elements defined as elements to be extracted in order to be included in a summary;

extracting the summary elements included in document data to be analyzed;

combining the extracted summary elements in accordance with a predetermined rule and generating summary information of the document data to be analyzed; and

linking the document data to be analyzed with the summary information.

According to a still another embodiment of the present invention, there is provided a method of document analysis by a computer, comprising:

referring to term definition dictionary data including summary elements defined as elements to be extracted in order to be included in a summary;

extracting the summary elements included in document data to be analyzed;

combining the extracted summary elements in accordance with a predetermined rule and generating summary information of the document data to be analyzed;

linking the document data to be analyzed with the summary information;

when a designation of the summary information from a user is received, searching the document data to be analyzed corresponding to the designated summary information based on a link result between the document data to be analyzed and the summary information; and

generating screen data including the designated summary information and the searched document data to be analyzed.

According to a still another embodiment of the present invention, there is provided a method of document analysis by a computer, comprising:

receiving document data to be analyzed including index information indicative of a category under which the document data falls;

referring to term definition dictionary data including summary elements defined as elements to be extracted in order to be included in a summary;

extracting the summary elements included in the document data to be analyzed;

combining the extracted summary elements in accordance with a predetermined rule and generating summary information of the document data to be analyzed;

linking the document data to be analyzed with the summary information;

when a designation of the category from the user is received, searching the document data to be analyzed that falls under the designated category based on the index information;

searching the summary information corresponding to the searched document data to be analyzed based on a link result between the document data to be analyzed and the summary information; and

generating screen data including the searched document data to be analyzed, the category under which the searched document data falls and the searched summary information.

According to a still another embodiment of the present invention, there is provided a system of document analysis comprising:

a unit that refers to term definition dictionary data including summary elements defined as elements to be extracted in order to be included in a summary, and extracts the summary elements included in document data to be analyzed;

a unit that combines the extracted summary elements in accordance with a predetermined rule and generates summary information of the document data to be analyzed; and

a unit that links the document data to be analyzed with the summary information.

According to a still another embodiment of the present invention, there is provided a system of document analysis comprising:

a unit that refers to term definition dictionary data including summary elements defined as elements to be extracted in order to be included in a summary, and extracts the summary elements included in document data to be analyzed;

a unit that combines the extracted summary elements in accordance with a predetermined rule and generates summary information of the document data to be analyzed;

a unit that links the document data to be analyzed with the summary information; and

a unit that, when a designation of the summary information from a user is received, searches the document data to be analyzed corresponding to the designated summary information based on a link result between the document data to be analyzed and the summary information, and generates screen data including the designated summary information and the searched document data to be analyzed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinbefore.

### BRIEF DESCRIPTION OF THE SEVERAL VIEWS OF THE DRAWING

The accompanying drawings, which are incorporated in and constitute a part of the specification, illustrate embodiments of the present invention, and together with the general description given above and the detailed description of the embodiments given below, serve to explain the principles of the present invention in which:

FIG. 1 is a block diagram showing an example of the structure of a document analysis system according to a first embodiment of the present invention;

FIG. 2 is a diagram showing screen data generated by the document analysis system according to this embodiment;

FIG. 3 is a flowchart showing an example of the operation of the document analysis system according to this embodiment;

FIG. 4 is a diagram showing an example of the extract result of a summary element obtained by an extracting function of a summarizing/extracting function;

FIG. 5 is a diagram showing an example of the state in which display conditions are designated based on a hierarchy;

FIG. 6 is a diagram showing an example of the state in which conditions of the same hierarchy are designated by the user;

FIG. 7 is a flowchart showing an example of the process to realize designation of display conditions of the same hierarchy;

FIG. 8 is a diagram showing an example of the method of combining designation of a past display condition and designation of a new display condition;

FIG. 9 is a diagram showing an example of the state in which the corresponding portion of the document data is highlighted by designation of summary information; and

FIG. 10 is a block diagram showing an example of the provision pattern of a service performed by the document analysis program.

### DETAILED DESCRIPTION OF THE INVENTION

Embodiments of the present invention will be described with reference to the drawings. In the drawings, same reference numerals denote the same or similar parts.

(First Embodiment)

In the description of this embodiment, a document analysis system for assisting an operation of analyzing document data on which report is written will be described.

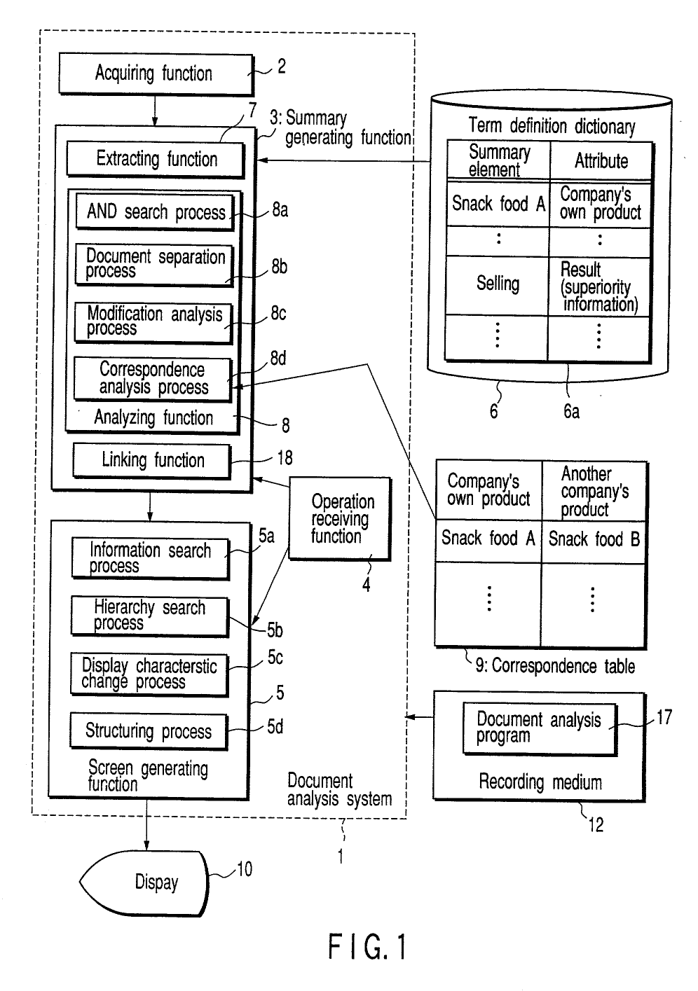

FIG. 1 is a block diagram showing an example of the structure of a document analysis assist system according to this embodiment.

A document analysis system 1 reads and executes a document analysis program 17 recorded in a recording medium 12.

When the document analysis program 17 is read and executed by the system 1, it accomplishes an acquiring function 2, a summary generating function 3, an operation receiving function 4 and a screen generating function 5. The document analysis system 1 refers to a term definition dictionary 6a recorded in a database 6.

The acquiring function 2 acquires document data to be analyzed. In this embodiment, it is assumed that the document data is report data, such as business daily report of a maker. The document data includes index information for classifying the document data, such as the name of a reporter, the date and time of the report, the names of shops and dates. For example, bibliographic items of the document data can be used as the index information.

A summary element, defined as an element extracted from the document data so that it can be included in a summary, and an attribute of the element are registered in the term definition dictionary 6a in association with each other. As summary elements, the user can freely define contents to be extracted, for example, a part of a word, a word, a phrase, a clause, an expression, etc.

For example, it is assumed that the attribute “the company's own product” is associated with the summary element “Snack Food A”, and the attribute “another company's product” is associated with the summary element “Snack Food B” in the term definition dictionary 6a. Further, it is assumed that the attribute “result-superiority information” is associated with the summary element “selling”, and the attribute “result-inferiority information” is associated with the summary element “sluggish selling”. Still further, it is assumed that the attribute “action” is associated with the summary element “tasting party” and the attribute “action” is associated with “advertisement”.

The summary generating function 3 includes an extracting function 7, an analyzing function 8 and a linking function 18.

The extracting function 7 receives the document data acquired by the acquiring function 2 and refers to the term definition dictionary 6a. The extracting function 7 compares the summary element registered in the term definition dictionary 6a with the document data. If the sentence data contains the same expression as the summary element registered in the term definition dictionary 6a, the extracting function 7 records the summary element, the attribute and the positional information in the sentence data.

The analyzing function 8 combines the summary elements or attributes extracted by the extracting function 7 based on predetermined rules, thereby generating summary information. For example, combining of extracted summary elements, in accordance with the rule “product-action”, the rule “product-result”, the rule “product-action-result”, etc., is set in the analyzing function 8.

The analyzing function 8 can combine summary elements with each other, a summary element with an attribute, or attributes with each other.

Processes of judging the combination of the extracted summary information or attributes include, for example, an AND search process 8a, a document separation process 8b, a modification analysis process 8c, a correspondence analysis process 8d, etc.

The operation receiving function 4 receives designation of the judging process from the user, and informs the analyzing function 8 about it.

In the AND search process 8a, combinations of all summary elements or attributes extracted in accordance with the rules are generated.

In the document separation process 8b, the document data is separated in accordance with a predetermined document separation rule, and extract results obtained by the extracting function 7 are combined using the separated state. For example, the sentence data is separated by “.”, “,” or the like. Then, the extracted summary elements or attributes within the separated field are combined in accordance with the predetermined rule.

In the modification analysis process 8c, it is determined whether an extracted summary element is an object of comparison. The summary elements that are determined to be objects of comparison are excluded from the candidates for combination, and the AND search process 8a or the document separation process 8b is executed using the remaining summary elements. For example, whether the extracted summary element is an object of comparison or not is determined on the basis of the elements representing comparison, such as “ . . . er”, “than”, “far . . . than”, “as compared to . . . ”, “the ratio of . . . to”, etc. and the position of the extracted summary element.

In the correspondence analysis process 8d, a correspondence table 9, in which summary elements in comparison are correlated, is referred to. Further, in the correspondence analysis process 8d, if the extracted summary element includes an element representing comparison and a summary element to be compared with this summary element has not been extracted, a summary element in the relationship to be compared with the extracted summary element is obtained from the correspondence table 9. Then, in the correspondence analysis process 8d, the summary element extracted by the extracting function 7 and the summary element obtained from the correspondence table 9 are combined.

For example, the company's own product and another company's product, which compete with each other, are correlated in the correspondence table 9. Then, it is assumed that analysis is carried out with respect to the document data “selling better than another company's product”.

In this case, the term “another company's product” with the word “than” representing comparison is extracted. Since there is no object to be compared with “another company's product”, “the company's own product” is obtained from the correspondence table 9, and the resultant combination of “the company's own product” and “selling” is obtained.

The summary generating function 3 generates summary information, such as “Snack Food A is selling”, in connection with the document data, for example, “Snack Food A is selling in July on the market”. Further, it is understood from the attribute of the summary element that the document data includes superiority information of the company's own product.

When the operation receiving function 4 receives choice contents of the judging processes 8a to 8d for use in the summary generating function 3, it informs the analyzing function 8 of the summary generating function 3 about the contents.

Further, when the operation receiving function 4 receives designated contents by the user relating to a screen display, it informs the screen generating function 5 about the designated contents.

The linking function 18 provides a link between the document data and the summary information generated by the analyzing function 8. The linking function 18 links together document data having the same summary information via the same summary information.

The screen generating function 5 generates screen data, in which the index information, the summary information extracted by the summary generating function 3, and the document data, i.e., the text of the daily report, are combined. The screen data is displayed on a display 10.

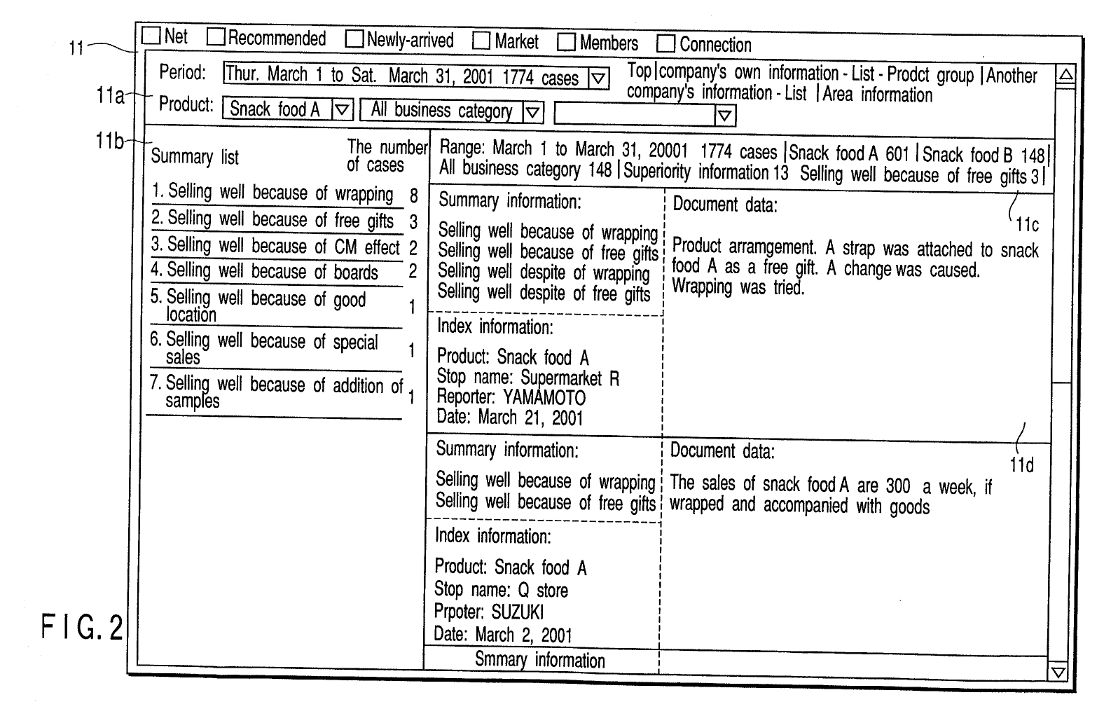

FIG. 2 is a diagram showing an example of screen data generated by the document analysis assist system 1.

A screen 11 includes condition designating regions 11a and 11b for the user to select display conditions in accordance with the hierarchy of “period”, “name of the product”, “business category”, “whether superiority information of inferiority information” and “contents of summary information” in this order. In the condition designation region 11b to choose the contents of the summary information, the number of cases of the extracted summary information corresponding to the document data for the respective contents of the summary information.

The display conditions are designated by hierarchically combining the index information and the summary information.

The screen 11 includes a region 11c, which displays the current designated status of the display conditions.

The screen 11 includes a list region 11d, which displays in list form the document data that satisfies the designated display conditions, all summary information generated from the document data and the index information including the document data in combination.

When the user who refers to the screen 11 designates index information indicated in the list region 11d via the operation receiving function 4, the screen generating function 5 searches document data including the designated index information.

The screen generating function 5 combines the searched document data, the index information included in the searched document data and the summary information generated from the searched document data, thereby generating screen data to be displayed in a list form.

On the other hand, when the user who refers to the screen 11 designates summary information indicated in the list region lid via the operation receiving function 4, the screen generating function 5 searches the document data linked to the designated summary information. Then, it combines the searched document data, the index information included in the searched document data and the summary information generated from the searched document data, thereby generating screen data to be displayed in a list form.

Thus, the screen generating function 5 comprises an information search process 5a which searches document data in accordance with the summary information or index information designated by the user, and a hierarchy search process 5b which searches document data in accordance with the display condition (search key) hierarchically designated by the user.

The screen generating function 5 comprises a display characteristic change process 5c which changes the display characteristic of a portion corresponding to the summary information of document data, and a structuring process 5d which writes the searched document data in XML (Extensible Markup Language).

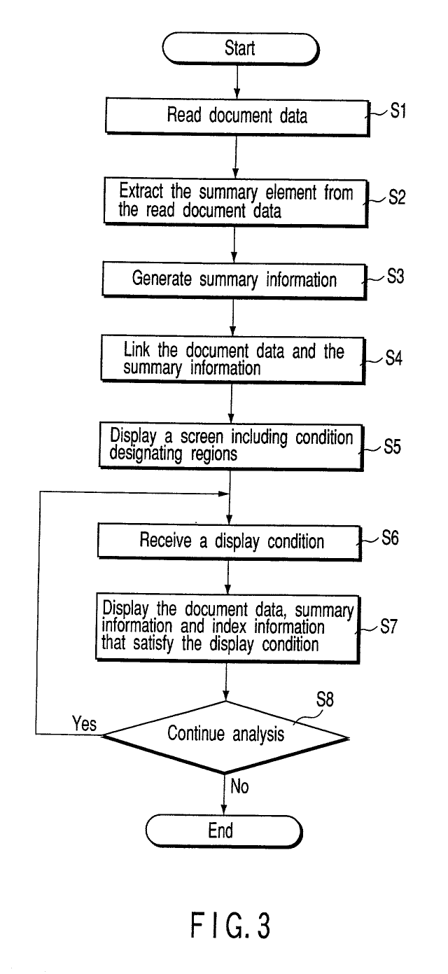

FIG. 3 is a flowchart showing an example of the operations of the document analysis system 1 having the above structure.

In a step S1, the acquiring function 2 of the document analysis system 1 reads document data to be analyzed.

In a step S2, the extracting function 7 of the document analysis system 1 extracts predetermined summary elements from each of the read document data.

In a step S3, the analyzing function 8 of the document analysis system 1 generates summary information based on the extracted summary elements.

In a step S4, the linking function 18 of the document analysis system 1 links the document data and the summary information.

In a step S5, the screen generating function 5 of the document analysis system 1 displays the screen 11 including the condition designating regions 11a and lib for the user to designate display conditions.

The user designates document data to be displayed, by using the pull-down menus in the condition designating region 11a or the list of the condition designating region 11b.

For example, the user indicates that the date of the index information is “Mar. 1 to Mar. 31, 2002”, the products of the index information are “Snack Food A” and “Snack Food B”, and the summary information has the attribute “superiority information”, and designates linkage with the summary information “selling well because of free gifts” as the display condition.

In a step S6, the operation receiving function 4 of the document analysis system 1 receives the display condition designated by the user.

In a step S7, the screen generating function 5 displays a list, in which the document data, the summary information thereof and the index information thereof that satisfy the display condition are combined.

In a step S8, the document analysis system 1 repeats reception of designation of the display condition and display of the contents that satisfy the display condition, so long as the analysis operation by the user continues. The user refers to the index information and summary information displayed as the list. If the user wishes to continue the analysis, the user designates (clicks) an indication of the index information or the summary information by the mouse, thereby designating a new display condition. Index information and summary information can be combined freely and designated as a display condition.

As described above, the document analysis assist program 1 receives the display condition designated by the user, and displays a new list in which the document data, the summary information thereof and the index information thereof that satisfy the display condition are combined.

Effects obtained by using the document analysis system 1 will be described below.

For example, a company uses enormous volumes of document data, such as daily report data, monthly report data, business report data and shop management daily data.

The user activates the document analysis system 1, and makes the document analysis system 1 read the collected document data. Then, summary information is generated on the basis of the document data.

The user classifies and summarizes the document data in accordance with the contents of the generated summary information by using the document analysis system 1. As a result, the user can easily obtain quantitative information, for example, “there are much information on a product”, “there are much information of ‘selling well because of a sales promotion activity’” and “there are much information on a competing company's product”.

Further, the user can automatically classify the document data in terms of product, maker, or business section and use it for analysis.

The user can grasp the market condition by displaying the number of cases of every item of summary information, without executing the search or the like.

The user can grasp the content of a large volume of document data by reading the displayed summary information, without reading a large volume of document data.

When the display condition is designated by the user, the document analysis system 1 displays, along with the search results, display conditions of meanings different from that of the display condition designated by the user, as shown in the screen 11 in FIG. 2.

More specifically, if the display condition of the summary information “selling well because of free gifts” is designated, displayed information are not only the document data searched on the basis of the designated display condition, but also other summary information completely different from the designated summary information and linked to the searched document data, for example, “selling bad despite wrapping”. The same applies to the index information.

It is assumed that the user hierarchically designates a display condition. In this case, to designate the display condition of “selling bad despite wrapping” of the “inferiority information”, the user must designate first “inferiority information” and then “selling bad despite wrapping”. However, the document analysis system 1 has a function of not only hierarchically designating the display condition, but also directly switching a screen displayed on the basis of a display condition to another screen displayed on the basis of another display condition. Thus, the operability for the user is improved.

In other words, a list that satisfies a condition can be easily switched to a list that satisfies another condition by utilizing the document analysis system 1. In addition, since the user can freely designate a display condition regardless of hierarchy by utilizing the document analysis system 1, the operability for the user can be improved.

(Second Embodiment)

In the description of this embodiment, the summary generating function 3 of the first embodiment will be described in detail.

It is assumed that the summary elements of trade names, such as “Snack Food A”, “Snack Food B” and “Snack Food C”, and the summary elements concerning the action or results, such as “tasting party”, “sold out” and “selling”, are registered in the term definition dictionary 6a.

It is also assumed that the extracting function 7 of the summary generating function 3 receives the sentence data “Snack Food B was sold out in the tasting party. Information of Snack Food A. Selling 120% of Snack Food C.”

In this case, the extracting function 7 extracts the summary elements of the trade names “Snack Food A”, “Snack Food B” and “Snack Food C”, and the summary elements concerning the action or results “tasting party”, “sold out” and “selling”, which are contained in both the document data and the term definition dictionary 6.

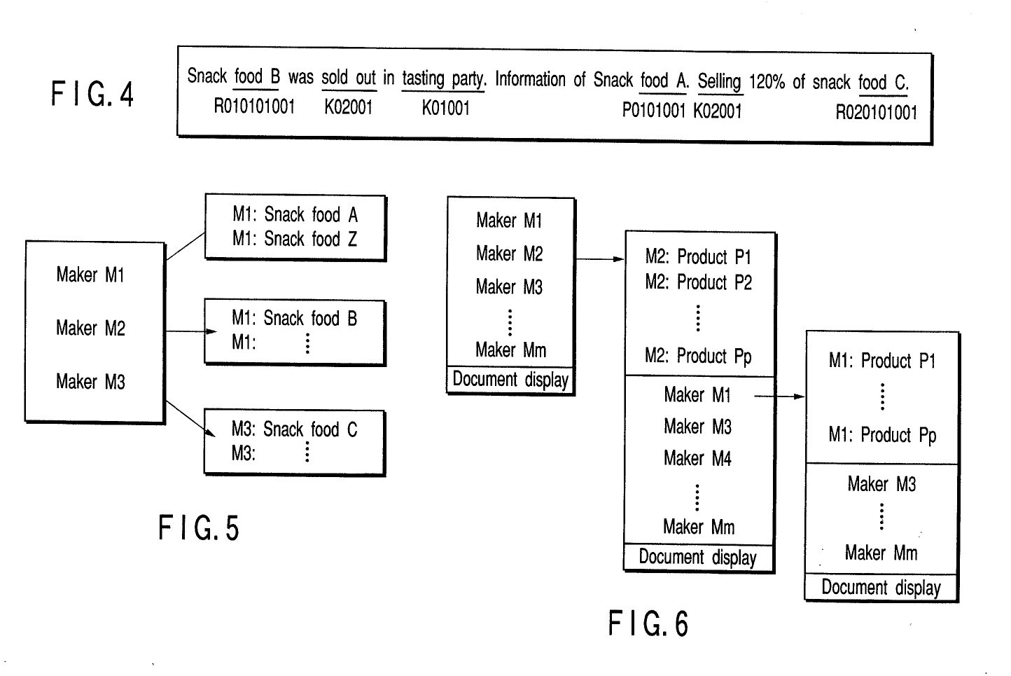

FIG. 4 is a diagram showing an example of the result of extraction of summary elements by the extracting function 7 of the summary generating function 3. The summary elements, the positions thereof and the element IDs are extracted.

The analyzing function 8 of the summary generating function 3 combines the extracted summary elements in accordance with a predetermined rule, thereby generating summary information.

The correspondence table 9 is a table referred to in the correspondence analysis process 8d. In the correspondence table 9, the trade names of “Snack Food A”, “Snack Food B” and “Snack Food C”, which compete with one another, are correlated and registered in the correspondence table 9.

Regarding the above document data “Snack Food B was sold out in the tasting party. Information of Snack food A. Selling 120% of Snack Food C.”, the correct combinations of “a product” and “an action or result” are three: “Snack Food B—tasting party”; “Snack Food B—sold out” and “Snack Food A—selling”.

The following are analysis accuracies of the above judging processes 8a to 8d evaluated in terms of precision ratio (ratio of summaries having correct contents to all generated summaries) and recall ratio (ratio of correct contents actually contained in the summaries to all correct contents that must be contained in the summaries). It is assumed that the combination rules are “product-action” and “product-result”.

In the AND retrieval process 8a, all combinations of the extracted summary elements are generated in accordance with the combination rules. Therefore, the AND search process 8a generates the following nine items of summary information: “Snack Food B—tasting party”; “Snack Food B—sold out”; “Snack Food B—selling”; “Snack Food A—tasting party”; “Snack Food A—sold out”; “Snack Food A—selling”; “Snack Food C—tasting party”; “Snack Food C—sold out”; and “Snack Food C—selling”. With respect to this result, the precision ratio is about 33% and the recall ratio is 100%. Therefore, if the user places higher priority on the recall ratio to generate summary information from the document data, the user chooses the AND search process 8a by means of the operation receiving function 4.

In the document separation process 8b, the document data is separated by “.”, and AND search is performed within this separated field. Therefore, the document separation process 8b generates the following three items of summary information: “Snack Food B—tasting party”; “Snack Food B—sold out”; and “Snack Food C—selling”. With respect to this result, the precision ratio is about 66% and the recall ratio is about 66%. Therefore, if the user places the same priority on the precision ratio and the recall ratio to generate summary information from the document data, the user chooses the document separation process 8b by means of the operation receiving function 4.

The modification analysis process 8c searches for a product that is located within or before the field separated by “.” and closest to the extracted product and that do not concern a predetermined exclusion terms, which are defined as being excluded from the combinations, and combines. Therefore, the modification analysis process 8c generates the following three items of summary information: “Snack Food B—tasting party”; “Snack Food B—sold out”; and “Snack Food A—selling”. With respect to the precision ratio of this result, the precision ratio is 100% and the recall ratio is 100%.

When no product is extracted in the modification analysis process, the correspondence analysis process 8d obtains the company's own product corresponding to another company's product relating to the exclusion terms and executes combination using the obtained the company's own product. Therefore, the correspondence analysis process 8d generates the following three items of summary information: “Snack Food B—tasting party”; “Snack Food B—sold out”; and “Snack Food A—selling”. With respect to this result, the precision ratio is 100% and the recall ratio is 100%.

Therefore, if the user places the priority on both the precision ratio and the recall ratio to generate summary information from the document data, the user chooses the modification analysis process 8c or the correspondence analysis process 8d by means of the operation receiving function 4.

Then, when a superiority result or a superiority action is combined with “the company's own product”, the summary generating function 3 determines that the summary information is superiority information.

On the other hand, when an inferiority result or an inferiority action is combined with “the company's own product”, and when a superiority result or a superiority action is combined with “another company's product”, the summary generating function 3 determines that the summary information is inferiority information.

As described above, the document analysis system 1 enables the analyzing function 8 that generates summary information to execute a plurality of judging processes 8a to 8d. The user can freely choose from the judging processes 8a to 8d. Therefore, the display can be changed flexibly in accordance with the quality of the document data to be analyzed or the needs of the user.

(Third Embodiment)

In the description of this embodiment, a modification of the document analysis system 1 according to the first embodiment will be described.

FIG. 5 is a diagram showing an example of the statuses in which display conditions are designated on the basis of hierarchy. In FIG. 5, first, display conditions about makers are designated in a first hierarchy, and then display conditions about products of the makers are designated in a second hierarchy.

Thus, in the system in which a display condition in an order lower than the display condition designated by the user is designated, a plurality of display conditions of the same hierarchy cannot be designated. For example, it is impossible to designate both Maker M1 and Maker M2.

Therefore, if there is a need for “displaying document data containing information of both Snack Food B of Maker M2 and Snack Food C of Maker M3”, the user can only extract for him/herself the document data relating to Snack Food C of Maker M3 from the document data relating to Snack Food B of Maker M2 or the document data relating to Snack Food B of Maker M2 from the document data relating to Snack Food C of Maker M3.

Hence, the screen generating function 5 of this embodiment enables designation of display conditions in the same hierarchy level, such as Makers M1 and M2, in upper and lower hierarchies, as shown in FIG. 6, so that the user can designate a display condition in the same hierarchy as the designated display condition.

FIG. 6 is a diagram showing an example of the state in which conditions of the same hierarchy are designated by the user.

When the user designates a display condition, the screen generating function 5 of this embodiment displays all display conditions in the lower hierarchy having a hierarchical relationship with the designated display condition, a list including undesignated display conditions that belong to the same hierarchy as that of the designated display condition, and “Document Display”.

Then, at the stage where “Document Display” is designated by the user, the screen generating function 5 searches document data that satisfies the designated display condition, the summary information thereof and the index information thereof, and combines them to generate screen data.

In FIG. 6, the names of all makers M1 to Mm are first indicated as a list of the display conditions. When the user designates “Maker M2” from the list, a list is displayed, which indicates the products of Maker M2, i.e., “Product P1” to “Product Pp”, and the makers excluding Maker M2, i.e., “Makers M1”, “Maker M3” to “Maker Mm”.

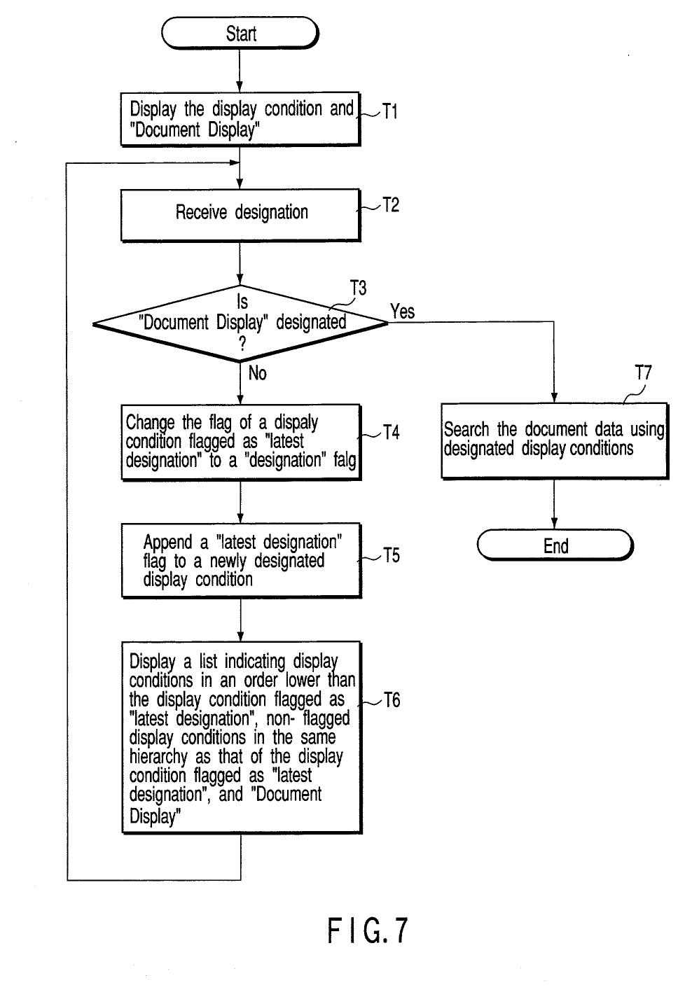

FIG. 7 is a flowchart showing an example of the process to realize designation of display conditions of the same hierarchy.

In a step T1, the screen generating function 5 displays a list indicating display conditions in a hierarchy and “Document Display”.

In a step T2, the screen generating function 5 receives designation with respect to the list.

In a step T3, the screen generating function 5 determines whether “Document Display” is designated or not.

If “Document Display” is not designated, the document generating function 5 changes the flag of the display condition flagged as “latest designation” to a “designation” flag, in a step T4.

In a step T5, the screen generating function 5 appends the “latest designation” flag to the newly designated display condition.

In a step T6, the screen generating function 5 displays a list indicating display conditions in an order lower than the display condition flagged as “latest designation”, non-flagged display conditions in the same hierarchy as that of the display condition flagged as “latest designation”, and “Document Display”.

The processes of the step T2 and the subsequent steps are repeated until “Document Display” is designated. When “Document Display” is designated, the screen generating function 5 searches document data using all display conditions flagged as “designation” as search keys, and generates screen data, in a step T7.

In this embodiment, the user can designate a plurality of display conditions in the same hierarchy. As a result, display conditions in the same hierarchy can be flexibly designated, as well as top-down display conditions, such as “maker names”, “summary information” and “document data”. Therefore, the operability for the user can be improved. Accordingly, search in accordance with the needs of the user is much more enabled as compared to the case in which the hierarchy of display conditions, such as “makers”, “summary information” and “document data”, and the number of hierarchies are determined fixedly.

According to the description of this embodiment, designation in the same hierarchy is enabled with respect to “makers”. However, designation of a plurality of display conditions in the same hierarchy may be enabled with respect to another hierarchy. Further, designation of display conditions in the same hierarchy may be enabled with respect to a plurality of hierarchies.

(Fourth Embodiment)

In the description of this embodiment, a modification of the document analysis system 1 according to the third embodiment will be described.

In this embodiment, as in the above embodiments, a link is provided between the displayed document data and summary information. Then, when the summary information of, for example, “Selling bad despite wrapping”, is clicked, the document data linked with this summary information is displayed on the screen. Switching between screens in this embodiment utilizes the method of designating a display condition as described above in connection with the third embodiment.

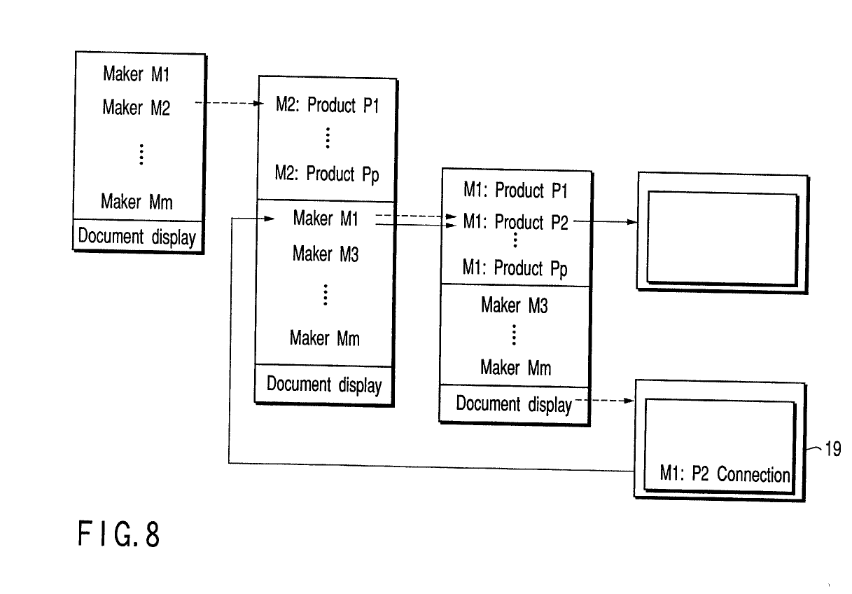

FIG. 8 is a diagram showing an example of the method of combining designation of a past display condition and designation of a new display condition.

It is assumed that the user narrows the display conditions down to “Maker M2”, “Maker M1” and “Document Display”. In this case, the document data that satisfies the display conditions is searched and a screen 19 is displayed.

It is assumed that “Maker M1” and “Product P2” are newly designated as display conditions on the displayed screen 19. In this case, the screen generating function 5 traces the user's past narrow-down designation in the reverse order, as indicated by the solid arrow in FIG. 8, and returns to the state where “Maker M1” is designated. Then, “Product P2” is designated as a display condition of the lower order than “Maker M1”.

In this embodiment, if the user designated the same condition as the new display condition or designated a display condition that belongs to the same hierarchy as that of the new display condition, display conditions are constituted to include the new condition and the display conditions covering the display conditions designated in the past, and document data is searched.

On the other hand, if a display condition that has not been designated by the user in the past is designated on the displayed screen, the process returns to the top of the hierarchy and document data is searched on the basis of only the designated display conditions.

Therefore, the user designates the display conditions while the past narrow-down operation is kept alive, so that the document data can be displayed. As a result, the user can easily obtain specified display contents.

(Fifth Embodiment)

In the description of this embodiment, a modification of the document analysis system 1 according to the first to fourth embodiments will be described.

When summary information is clicked, the screen generating function 5 highlights the portion of the document data that corresponds to the summary information.

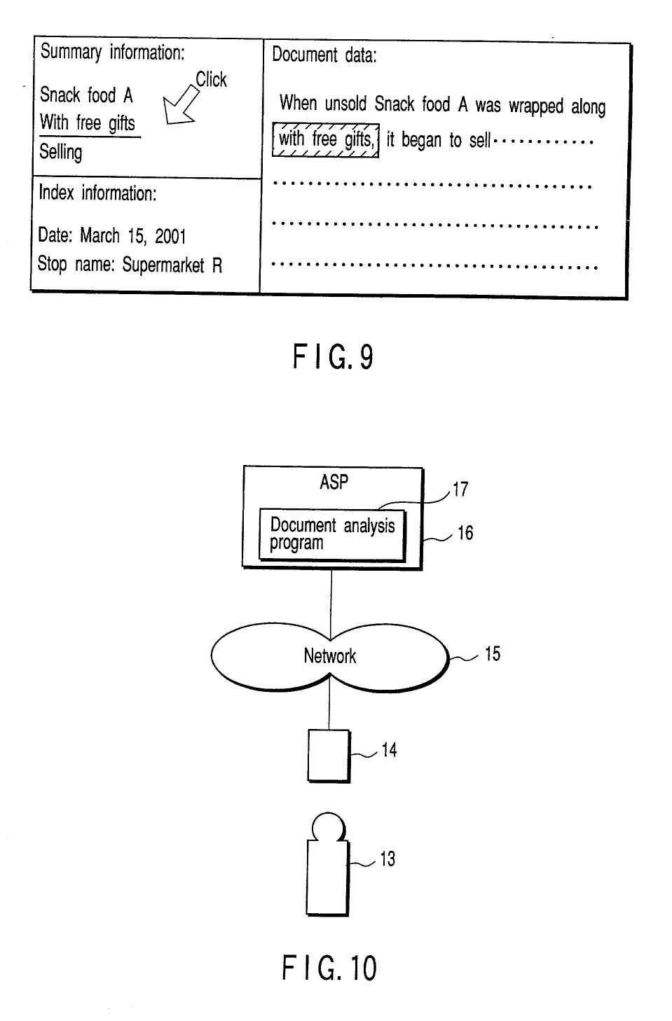

In FIG. 9, the summary information “with free gifts” of the display column of the summary information is clicked, and the corresponding portion “along with free gifts” of the document data is highlighted.

Such a function can be implemented by inserting a generation result of summary information as a tag in the document data when the summary generating function 3 generates summary information, and correlating it to a description in the summary information column.

For example, in the case of an HTML file, the summary information and the corresponding description in the document data are linked with each other. If clicked, an HTML file that includes the highlighted corresponding portion is displayed.

Note that, for example, the summary information may be displayed in a color in accordance with the type of the summary information in advance, and the document data corresponding to the summary information may be displayed in the color in accordance with the type of the summary information.

Thus, the user is clearly notified to what portion of the document data the summary information generated from the document data corresponds, so that the user can promptly recognize concrete description contents of the summary information, even if the amount of document data is great.

In addition, the user can grasp the contents by reading the descriptions before and after the description corresponding to the summary information without reading all document data containing the summary information. Therefore, the information integration density can be higher.

(Sixth Embodiment)

In the description of this embodiment, a modification of the document analysis system 1 according to the first to fifth embodiments will be described.

The screen generating function 5 describes the displayed portion of the document data on the screen with XML. As a result, a plurality of document data can easily be combined in the same manner as in the above embodiments.

Describing the displayed portion of the document data on the screen with XML allows arbitrary choice and combination of document data from an electronic file containing the plurality of document data.

The user can further edit the searched document data, further integrate the information and report it to the persons concerned. Thus, the convenience as a knowledge management system is improved.

The arrangement of the functions implemented by the document analysis system 1 according to each of the above embodiment may be changed, so far as similar effects and functions can be implemented. Further, the functions may be freely combined.

Moreover, the functions 2 to 5 implemented by the document analysis program 17 may be distributed over a plurality of computers and cooperatively operated.

The document analysis program 17 described in connection with the above embodiments is written in the recording medium 12, for example, a magnetic disk (a flexible disk, a hard disk, etc.), an optical disk (a CD-ROM, a DVD, etc.) and a semiconductor memory, so that it can be applied to a computer. Further, the program may be transmitted through a communication medium, so that it can be applied to a calculator or a calculator system.

The computer reads from the recording medium 12 the document analysis program 17 recorded in the recording medium 12, and the program controls its operation, thereby implementing the above functions.

(Seventh Embodiment)

In the description of this embodiment, the state of use of the document analysis program 17 described above in connection with the above embodiments will be described.

FIG. 10 is a block diagram showing an example of the state in which a service performed by the document analysis program 17 described in connection with the above embodiments is provided through an ASP (Application Service Provider).

The user 13 utilizes the document analysis program 17 managed by an ASP 16 via a network 15, such as the Internet, from its own terminal 14. As a result, the document data analyzing operation can be performed efficiently and easily.

With reception of the provision of the service of the ASP 16, the user 13 can utilize analysis services more efficiently in terms of maintenance and serviceability as compared to the case where the user manages the document analyzing program 17 by itself.

The ASP 16 can provide the user with an analysis support service and obtain a consideration from the user.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. An article of manufacture comprising a computer usable medium having computer readable program code means embodied therein, the computer program code means comprising:
a computer readable program code that refers to term definition dictionary data including summary elements defined as elements to be extracted in order to be included in a summary, and extracts the summary elements included in document data to be analyzed;
a computer readable program code that combines the extracted summary elements in accordance with a predetermined rule and generates summary information of the document data to be analyzed; and
a computer readable program code that links the document data to be analyzed with the summary information.

2. An article of manufacture comprising a computer usable medium having computer readable program code means embodied therein, the computer program code means comprising:
a first computer readable program code that refers to term definition dictionary data including summary elements defined as elements to be extracted in order to be included in a summary, and extracts the summary elements included in document data to be analyzed;
a second computer readable program code that combines the extracted summary elements in accordance with a predetermined rule and generates summary information of the document data to be analyzed;
a third computer readable program code that links the document data to be analyzed with the summary information; and
a fourth computer readable program code that, when a designation of the summary information from a user is received, searches the document data to be analyzed corresponding to the designated summary information based on a link result between the document data to be analyzed and the summary information, and generates screen data including the designated summary information and the searched document data to be analyzed.

3. The article of manufacture comprising a computer usable medium according to claim 2, wherein the fourth computer readable program code is a code that characterizes a portion of the document data to be analyzed, which corresponds to the summary information, included in the screen data.

4. The article of manufacture comprising a computer usable medium according to claim 2, wherein the fourth computer readable program code is a code that generates the screen data that makes the user hierarchically designate search keys for use in search of the document data to be analyzed, searches the document data to be analyzed based on the search keys designated by the user, searches the summary information corresponding to the searched document data to be analyzed based on the link result between the document data to be analyzed and the summary information, and generates the screen data including the searched document data to be analyzed and the searched summary information.

5. The article of manufacture comprising a computer usable medium according to claim 4, wherein the fourth computer readable program code is a code that, when a search key in an arbitrary hierarchy is designated by the user, generates the screen data that makes the user designate a next search key from a search key in a hierarchy of an order lower than the arbitrary hierarchy and the search key in the arbitrary hierarchy.

6. The article of manufacture comprising a computer usable medium according to claim 4, wherein the fourth computer readable program code is a code that, when a search key in an arbitrary hierarchy is designated by the user, searches the document data to be analyzed based on the search key designated in the arbitrary hierarchy and a search key designated in a hierarchy of an order higher than the arbitrary hierarchy before the arbitrary hierarchy is designated.

7. The article of manufacture comprising a computer usable medium according to claim 2, wherein:
the document data to be analyzed includes index information indicative of a category under which the document data falls; and
the fourth computer readable program code is a code that, when a designation of the category from the user is received, searches the document data to be analyzed that falls under the designated category based on the index information, searches the summary information corresponding to the searched document data to be analyzed based on the link result between the document data to be analyzed and the summary information, and generates the screen data including the searched document data to be analyzed, the category under which the searched document data falls and the searched summary information.

8. The article of manufacture comprising a computer usable medium according to claim 7, wherein the fourth computer readable program code is a code that generates the screen data that makes the user hierarchically designate the category and the summary information, searches the document data to be analyzed that satisfies a search condition generated based on the designation from the user, and generates the screen data including the searched document data to be analyzed, the category under which the searched document data falls and the searched summary information.

9. The article of manufacture comprising a computer usable medium according to claim 8, wherein the fourth computer readable program code is a code that, when the category or the summary information in an arbitrary hierarchy is designated by the user, generates the screen data which makes the user designate the next category or the summary information from the category or the summary information in a hierarchy of an order lower than the arbitrary hierarchy, and the category or the summary information in the arbitrary hierarchy.

10. The article of manufacture comprising a computer usable medium according to claim 8, wherein the fourth computer readable program code is a code that, when the category or the summary information in an arbitrary hierarchy is designated by the user, searches the document data to be analyzed based on the category or the summary information designated in the arbitrary hierarchy and the category or the summary information designated in a hierarchy of an order higher than the arbitrary hierarchy before the arbitrary hierarchy is designated.

11. A method of document analysis by a computer, comprising:
referring to term definition dictionary data including summary elements defined as elements to be extracted in order to be included in a summary;
extracting the summary elements included in document data to be analyzed;
combining the extracted summary elements in accordance with a predetermined rule and generating summary information of the document data to be analyzed; and
linking the document data to be analyzed with the summary information.

12. A method of document analysis by a computer, comprising:
referring to term definition dictionary data including summary elements defined as elements to be extracted in order to be included in a summary;
extracting the summary elements included in document data to be analyzed;
combining the extracted summary elements in accordance with a predetermined rule and generating summary information of the document data to be analyzed;
linking the document data to be analyzed with the summary information;
when a designation of the summary information from a user is received, searching the document data to be analyzed corresponding to the designated summary information based on a link result between the document data to be analyzed and the summary information; and
generating screen data including the designated summary information and the searched document data to be analyzed.

13. A method of document analysis by a computer, comprising:
receiving document data to be analyzed including index information indicative of a category under which the document data falls;
referring to term definition dictionary data including summary elements defined as elements to be extracted in order to be included in a summary;
extracting the summary elements included in the document data to be analyzed;
combining the extracted summary elements in accordance with a predetermined rule and generating summary information of the document data to be analyzed;
linking the document data to be analyzed with the summary information;
when a designation of the category from the user is received, searching the document data to be analyzed that falls under the designated category based on the index information;
searching the summary information corresponding to the searched document data to be analyzed based on a link result between the document data to be analyzed and the summary information; and
generating screen data including the searched document data to be analyzed, the category under which the searched document data falls and the searched summary information.

14. A system of document analysis comprising:
a unit that refers to term definition dictionary data including summary elements defined as elements to be extracted in order to be included in a summary, and extracts the summary elements included in document data to be analyzed;
a unit that combines the extracted summary elements in accordance with a predetermined rule and generates summary information of the document data to be analyzed; and
a unit that links the document data to be analyzed with the summary information.

15. A system of document analysis comprising:
a unit that refers to term definition dictionary data including summary elements defined as elements to be extracted in order to be included in a summary, and extracts the summary elements included in document data to be analyzed;
a unit that combines the extracted summary elements in accordance with a predetermined rule and generates summary information of the document data to be analyzed;
a unit that links the document data to be analyzed with the summary information; and
a unit that, when a designation of the summary information from a user is received, searches the document data to be analyzed corresponding to the designated summary information based on a link result between the document data to be analyzed and the summary information, and generates screen data including the designated summary information and the searched document data to be analyzed.
